(19) United States
(12) Patent Application Publication
(10) Pub. No.: US 2011/0044526 A1
(43) Pub. Date: Feb. 24, 2011

(54) PROCESS AND APPARATUS FOR LUNG NODULE SEGMENTATION IN A CHEST RADIOGRAPH

(76) Inventors: Chao Liu, Tianjing (CN); Yongqiang Tan, Elmhurst, NY (US); Lihong Li, Shanghai (CN); Mantao Xu, Shanghai (CN); Jiwu Zhang, Shanghai (CN)

Correspondence Address: Carestream Health, Inc.;ATTN: Patent Legal Staff, 150 Verona Street, Rochester, NY, 14608, US

(21) Appl. No.: 12/988,372

(22) PCT Filed: Apr. 18, 2008
(86) PCT No.: PCT/CN2008/000800

§ 371 Date: Oct. 18, 2010

(51) Int. Cl. G06K 9/00

(52) U.S. Cl. 382/132

(57) ABSTRACT

The present invention has disclosed a method and apparatus for lung nodule segmentation in a chest radiograph. The method comprises preprocessing the chest radiograph and propagating the segmentation in the image based on the fast marching method. The method further includes design of velocity function. With the present invention, a fast and robust segmentation can be achieved.

### TECHNICAL FIELD

The present application relates to diagnostic medical imaging and in particularly to the Computer Aided Detection (CAD) of pulmonary nodules in a chest radiograph.

### BACKGROUND OF THE INVENTION

Lung cancer is one of the most common cancers. In 2007, lung cancer accounts for approximately 15% of all cancer diagnoses and 29% of all cancer deaths. It ranks to be the second mostly diagnosed cancers and the first cause of cancer deaths each year in our human being. Smoking has been substantiated to be a direct reason that leads to lung cancers, in addition to some other factors such as exposure to asbestos, radon, environmental deterioration, or secondhand smoking. In this regard, early diagnosis has been evidenced to be quite important.

For an early and a correct diagnosis of the lung cancer, chest radiographs are a very commonly adopted measure by the medical doctors to discover the lung cancer which, in a chest radiograph, is in many situations shown to be an opaque and a lumpy nodule within the lung. Medical doctors may diagnostically determine whether the shown image indicates a benign or malignant nodule by means of the correctly shown chest radiograph and adopt a further correct therapy to patients.

However the automatically computerized detection for a pulmonary nodule is very often faced with many difficulties due to the existence of the complicated anatomical structures in the chest radiograph. This is because in many situations the nodules themselves do not have clear edges, and their size and shape may vary from case to case and thus incur cumbersomeness to the medical doctors.

In addition, many suspicious nodules may be sometimes superimposed on other organisms or anatomical structures, e.g., on ribs, and are thus difficult to be segmented.

Many methods have been thus far developed to have limitations to undesirable segmentation of nodules. For instance, someone suggests a watershed method. However this method may often lead to an over-segmentation with a very high computational cost and the clustering and merging of over-segmented sub-regions may incur another problem, e.g., the irregular shape of segmented contours. Others suggest a region growing method. However this latter method needs to predetermine a stopping threshold and is hence lack of robustness.

In view of a good segmentation of suspicious regions being required to extract any class of powerful features, the present invention has provided a process based on fast marching method for nodule segmentation so that those aforesaid problems can be feasibly tractable.

### SUMMARY OF THE INVENTION

An objective of this invention is to provide a method for segmenting a suspicious region which suggests a pulmonary nodule in a chest radiograph.

Another objective of this invention is to provide a fast and robust segmentation process by incorporating the visual features of pulmonary nodules, e.g., shape, density and texture of nodules.

Aspects of the invention provide a process for lung nodule segmentation in a chest radiograph, which comprises of preprocessing to the chest radiograph and propagating the segmentation based on fast marching method.

The invention further provides an apparatus for segmenting a lung nodule in a chest radiograph, which comprises of a preprocessor preprocessing the chest radiograph to obtain a preprocessed image; a segmentation processor segmenting the nodule in the image based on fast marching method; and a video processor for outputting the segmentation result to a display.

### BRIEF DESCRIPTION OF THE DRAWINGS

Features as well as advantages of the present invention will become to be more apparent to those skilled in the art from the following detailed description of the preferred embodiments when taking reference to the accompanying figures in which identical figure references identify similar or corresponding objects throughout the entire description of the present invention.

In these figures,

FIG. 1 illustrates a process of the fast marching method of the present invention;

FIG. 2a-2f illustrate the propagation of the segmentation process according to one aspect of the invention;

FIG. 3 illustrates the propagation of the segmentation process according to another aspect of the invention;

FIG. 4 illustrates the narrow band defined in the fast marching method;

FIG. 5 illustrates a heap structure.

FIG. 6 illustrates a segmentation apparatus according to one preferred embodiment of the present invention;

FIG. 7 illustrates one possible constitution of the segmentation processor as that is shown in FIG. 6;

### DETAILED DESCRIPTION OF THE INVENTION

Generally, image segmentation is a process for partitioning a digital image into disjoint sets of connected pixels, one of which corresponds to the background and the remainders to the objects in the image which in the medical diagnosis may suggest an anatomical structure. Image segmentation can be approached as the process for either assigning pixels to the objects, or finding boundaries between the objects or between the objects and the background.

The non-restrictive illustrative embodiments of the present invention relate to a process and an apparatus for segmenting the nodule in a chest radiograph, in other words, a process and an apparatus for finding the boundary between a nodule and the background.

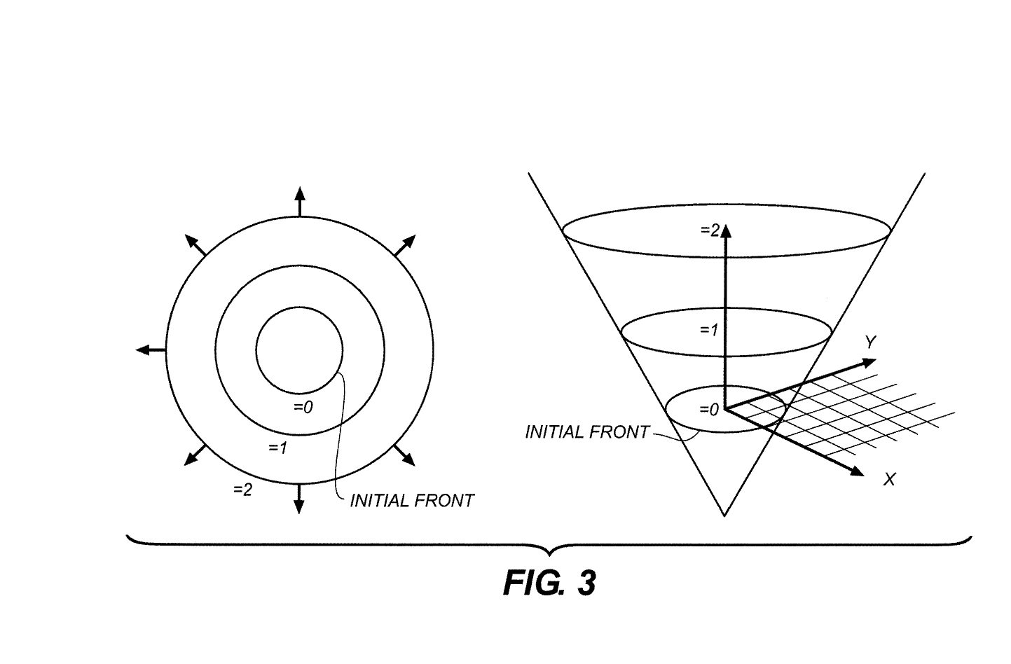

The fast marching (FM) method adopted in the present invention is illustrated in FIG. 3. Suppose there is an area which for simplicity of discussion is schematically depicted as an initial circle in FIG. 3. This initial circle schematically represents the initial seed points that may indicate part of a possible nodule. Let this initial circle expand so that the circle will become bigger and bigger until it stops at the defined boundary of the nodule. If we call the circle's edge at a specific time point to be a traveling front, then the FM method is to propagate the front of the initial circle until the front reaches the actual boundary of the nodule so that a picture of the nodule can be clearly defined.

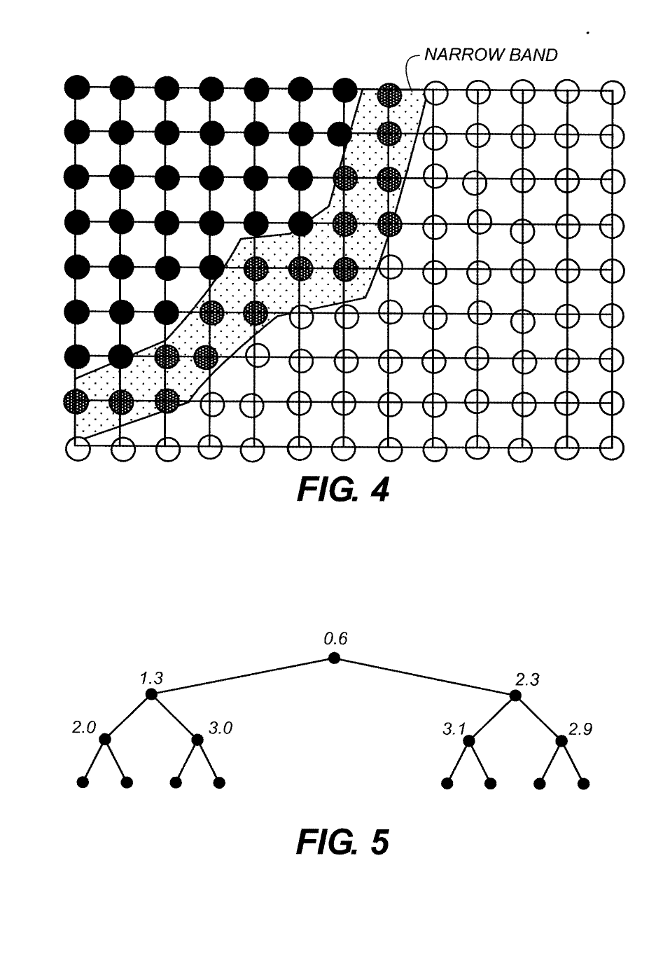

In the process of the propagation, the front will go past many points on respective circles. The time required for the front to travel from a smaller to a bigger circle is often in the art defined as the arrival time and is represented by letter u. It can be appreciated that the traveling front may go past each point only once. Then the task of the method is to determine which points should be considered to be included into the expanding circle by finding the point with the smallest value u among a narrow band in the periphery of the front of the circle (as shown in FIG. 4, wherein, the black spheres represent points in the circle, the dark gray spheres represent points in the narrow band). Here, the points are actually the pixels in an image. This can be understood by those in the art.

The arrival time u can be calculated in terms of the value of a velocity. The velocity function is formulated by the inversion of the exponential of a modulated projection gradient which represents an image. And the velocity function will be described in detail later. In the fast marching method, pixels within the nodules are with low gradients and thus lead to a faster propagation of the circle, while pixels around the nodule edges are often with high gradients where the velocity is slowed down.

The efficiency of the fast marching method lies in how fast to locate the points in the narrow band with the smallest value of arrival time u. Therefore, a concept of heap is utilized to store the arrival times of the fronts propagating to the respective pixels or points as that is commonly called.

In computer science, a heap is a specialized tree-based data structure that satisfies the heap (minimal) property:

If B is a child node of A, then key(A)≦(B).

This implies that an element with the smallest key is always in the root node, and therefore such a heap is sometimes called a minimum heap. Alternatively, if the comparison is reversed, then the greatest element is always in the root node, which results in a maximum heap. FIG. 5 shows an example of a minimum heap structure.

In the fast marching method, the point with the shortest arrival time u is always on the top of the heap. When a new point is accepted, the arrival time of this new point is added into the heap. Because of the property of the heap, only a small subset of the structure of the heap must be re-ordered, and thus it is easy to locate the point with the smallest arrival time. This heap data structure enables the algorithm to be accessible and manipulates the set of points as quickly as in logarithmic time.

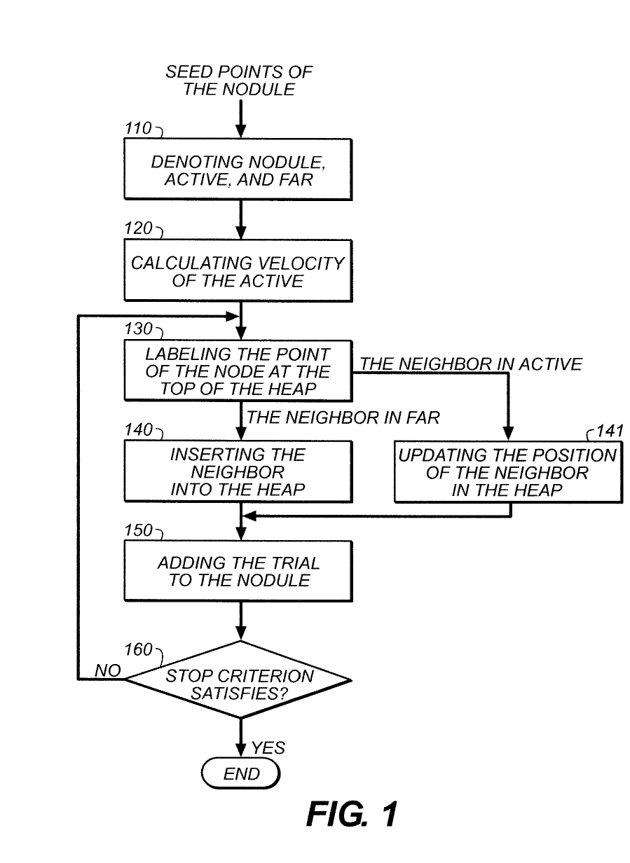

FIG. 1 illustrates a flow chart of the fast marching method of the present invention.

The fast marching method of the present invention utilizes seed points of the nodule as its input, and comprises following steps:

Step 110: Denote the seed points as nodule points, and the non-nodule neighbors of the nodule are labeled as active points. Label all remained points as far points.

Step 120: Calculate the velocity of the active points, and then calculate their arrival time. Place the active points in a min heap with top of which has the shortest arrival time.

Do following loop:

Step 130: Label the top point of the heap as a trial point, delete it from the heap, update the heap to restore minimal property of the heap;

Step 140: If the neighbor of the trial is a far point, calculate the far point's velocity and arrival time, and insert the far point into the heap;

Step 141: Else if the neighbor of the trial is an active point, re-compute the active point's velocity and update the active point's position in the heap;

Step 150: Add the trial point to the nodule set, in other words, accept the trial point as a part of the nodule.

Step 160: If a predetermined stop criterion is met, break the loop and stop. Or else, return to step 130 to repeat the loop.

The fast marching method of the present invention may adopt various stop criteria that may account for different kinds of enablement. For ease of description, we define the loop will stop when the arrival time≧T0, wherein T0 can be flexibly predefined.

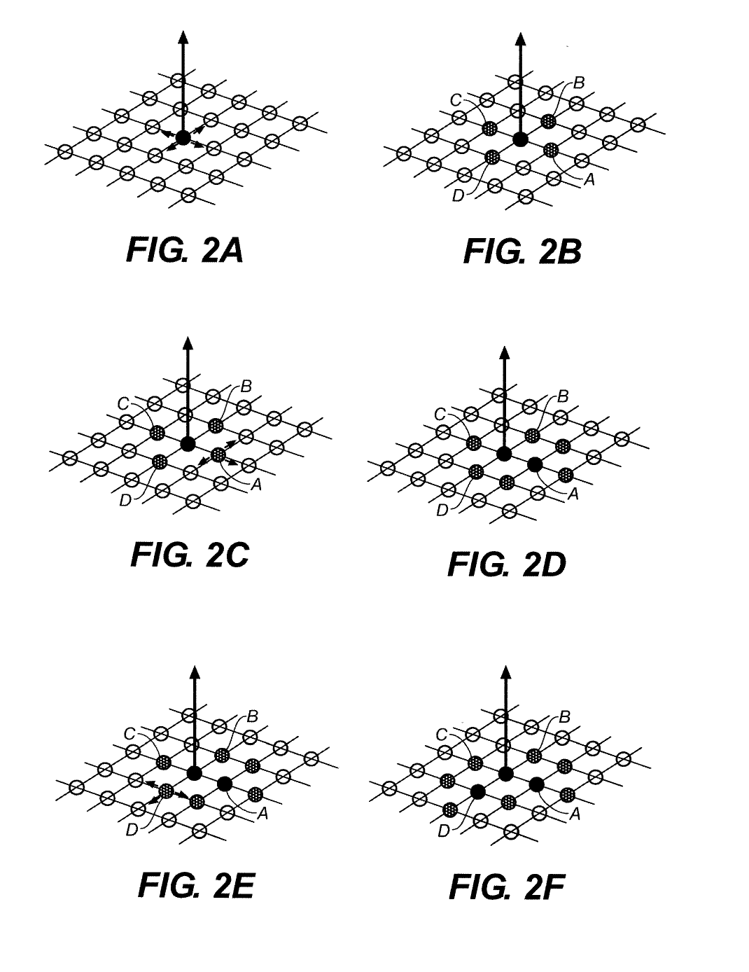

The propagation process is schematically shown in FIG. 2a to FIG. 2f. In these figures, black spheres represent accepted nodule points, the dark gray spheres represent active points, and white spheres represent far points. The dark gray spheres constitute a narrow band. FIGS. 2a and 2b illustrate that the method can start by marching “downwind” from a known value, computing new arrival times at each of the four neighboring grid points. Then, as shown in FIGS. 4c and 4d, freeze the arrival time at the smallest dark grey sphere (point A), and update neighboring downwind points. Sequentially, the method proceeds ahead.

FIGS. 4e and 4f show a next step similar to what is shown in FIGS. 4c and 4d. In these FIGS. 4e and 4f, point D is the smallest dark gray sphere. In the method described, “downwind” means the propagation is outward directed.

As having been described above, the velocity of the propagation is important for this process. It is therefore preferably that following velocity function has been formulated by the inventor:

V=a*exp(−gₘₚ*gₘₚ/(2σ²))*f(scale) (1)

To further conceive the aforesaid velocity function, one needs to firstly rescale the image intensity into a specific range which is represented by a modulation parameter k and which in the present invention is within [0 255]. Those skilled in the art may understand that this range can be chosen according to the actual medical practice.

For each pixel (i, j), the velocity function in formula (1) can be calculated through following steps:

(a) define parameter gₘₚ by following formula (2):

$${g}_{mp} = \{ \begin{matrix}6 , & if {gp}_{ij} / ( 1 - k ) < 6 \\ {gp}_{ij} / ( 1 - k ) & else\end{matrix} \qquad ( 2 )$$

wherein, gₘₚ=gpᵢⱼ/(1−k) means the projection of gradient is modulated by (1−k).

(b) define the modulation parameter k for projection gradient gₘₚ as:

$$k = \{ \begin{matrix}( 90 - {I}_{ij} ) / 90 & for 0 \leq {I}_{ij} < 90 \\ 0 & for 90 \leq {I}_{ij} \leq 137 \\ ( {I}_{ij} - 137 ) / 137 & for 137 < {I}_{ij} \leq 255\end{matrix} \qquad ( 3 )$$

This formula assumes that the nodule is not too dark or too light. Low intensity represents background, but high intensity represents bones;

(c) calculate gp_{if}, in formula (2), which is the projection of the gradient in velocity direction as:

gp_{if}=(∇I)_{if}·\vec{n} (4)

wherein I is the gray scale, \vec{n} is direction of the velocity.

(d) calculate a in formula (1) which is the scaling parameter as:

$$α = exp ( 1 - k ) or α = \frac{1}{1 + {( \frac{k}{0.5} )}^{2 n}} \qquad ( 5 )$$

(e) define parameter f (scale) , which is used for scaling the nodules according to the size of the nodule, for example, it can be defined as two sizes: the nodule with size in 5-15 mm is in scale 0 and the nodule size in15-30 mm is in scale 1, that is

$$f ( scale ) = \{ \begin{matrix}1 & if scale 0 \\ 2 & if scale 1\end{matrix} \qquad ( 6 )$$

A larger scale leads to the faster algorithm propagation that enables the segmented nodules with bigger size.

With all parameters calculated by aforesaid steps (a) to (e), velocity function V can be calculated.

And when the velocity function is thus derived, arrival time u of the front of the segmentation reaching each point can be calculated by resolving following equation (7):

[max (D_{if}^{-x}u,−D_{if}^{+x}u,0)²+max(D_{if}^{-y}u,−D_{if}^{+y}u,0)²]^{½}=1/V_{if}, (7)

where D⁻ and D⁺ are forward and backward operators which can be understood to be available from an ordinary art.

As having been described above, the seed points are used as the input of the fast marching method, which provides the initial front of the nodule. The seed points can be derived by various methods such as a manual operation. Preferably, the seed points can be found by a method called ICD (initial candidate detection) as that is known to the public in the art.

As well known, a pre-process to the image is commonly used before the segmentation to obtain a better effect. According to one aspect of the invention, two steps are adopted before selecting seed points:

The first step is to obtain a nodule-rib difference image by subtracting the nodule-enhanced image with the rib-enhanced image. This step is well known to those skilled in the art.

And the second step is to perform anisotropic diffusion filtering to the data of the suspicious nodule-rib difference image to enhance the image with a Gaussian shape while suppressing anatomical noises. The anisotropic diffusion filtering is required to smooth the nodule-rib difference image while preserving the edge, because any irregularity or existence of noises inside the nodule may lead to the slow-down in the propagation of the segmentation.

According to another aspect of the invention, there is provided an apparatus for segmenting lung nodule in the chest radiograph.

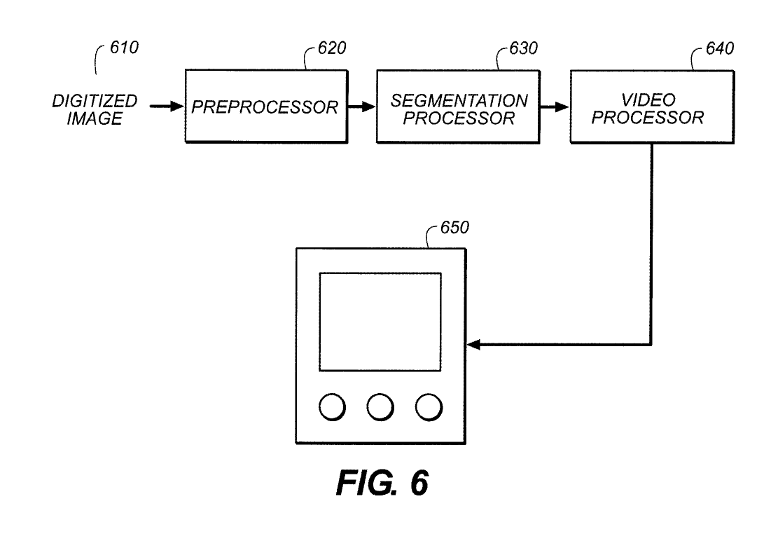

Referring now to FIG. 6, which illustrates an apparatus to segment a chest radiograph according to one embodiment of the present invention.

In FIG. 6, digitized image 610 is an input two-dimensional gray scale representation of a pulmonary region, obtained by digitizing the chest radiograph.

Preprocessor 620 receives the data of the input digitized image and executes a process of two steps:

The first step is to obtain a nodule-rib difference image by subtracting the nodule-enhanced image with the rib-enhanced image. And the second step is to perform anisotropic diffusion filtering to the data of the suspicious nodule-rib difference image to enhance the image with a Gaussian shape while suppressing anatomical noises.

The processed image is then output from preprocessor 620 to segmentation processor 630 where the nodule image is segmented in the way that has been described above. And the segmented image is further provided to a video processor 640 which outputs the segmentation result on display 650.

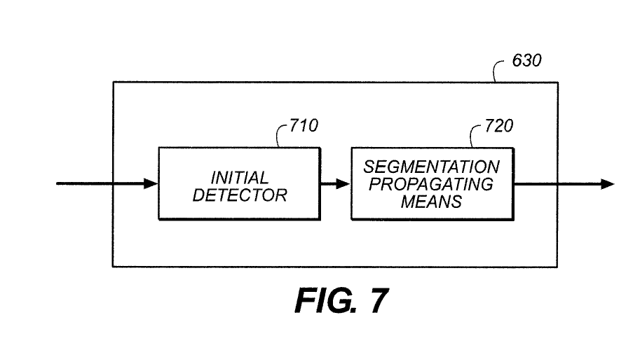

Referring now to FIG. 7 which schematically shows part of the configuration of segmentation processor in which an initial detector 710 is used for receiving the output from preprocessor 620, and detecting seed points of the nodule, preferably by an ICD (initial candidate detection) method as that is known to those skilled in the art. These seed points provide an initial front of the nodule. Then, means 720 for propagating segmentation is used for propagating the segmentation with the fast marching method of the present invention to propagate the front towards the actual boundary of the nodule.

With the present invention, the time for processing the segmentation can be significantly reduced from 100 to 20 seconds and the noise which affects the performance of segmentation can be almost eliminated.

The embodiments of the invention described above are intended to be exemplary only. However those skilled in the art may understand that the provided embodiments can be further varied in many aspects. For example, another range for the modulation parameter k can be defined according to the actual medical practice. The scope of the invention is therefore intended to be limited solely by the scope of the appended claims.

We claim:

1. A process for lung nodule segmentation in a chest radiograph, which comprises:
preprocessing to the chest radiograph to obtain a preprocessed image; and
propagating the segmentation based on fast marching method.

2. The process of claim 1, wherein the preprocessing step comprises:
enhancing nodule in the chest radiograph to obtain a nodule-enhanced radiograph;
enhancing rib in the chest radiograph to obtain a rib-enhanced radiograph;
obtaining a nodule-rib difference image by subtracting the nodule-enhanced radiograph with the rib-enhanced radiograph; and
applying anisotropic filter to the nodule-rib difference image.

3. The process of claim 1, wherein the propagating step comprises:
a) detecting seed points of the nodule in the image, wherein the seed points are the pixels that have been accepted as one part of the nodule;
b) denoting the seed points as nodule points, labeling non-nodule neighbor points of the nodule points as active points, and all remained points in the preprocessed radiograph as far points;
c) calculating firstly the velocity V of the active points and then their arrival times u, placing the active points in a small root heap, wherein the node at the top of the heap has the smallest arrival time u; the velocity V is calculated by a predefined velocity function; the arrival time u is defined by when the front of the accepted part of the nodule reaches the points in the image and can be calculated with the velocity V;
d) labeling the point of the node at the top of the heap as a trial point, deleting the trial point from the heap, updating the heap to restore minimal property;
e) if the neighbor of the trial is a far point, calculating its velocity and arrival time, and inserting the far point into the heap, or else if the neighbor of the trial is in a active point, re-computing the active point's velocity and updating the active point's position in the heap;
f) adding the trial point to the nodule points, accepting the trial point as a part of the nodule;
g) repeating steps d) to f) until a stop criterion is satisfied.

4. The process of claim 3, wherein the velocity function is formulated as:
V=a*exp(−gₘₚ*gₘₚ/(2σ²))*f(scale),
wherein, gₘₚ is defined as following:
$${g}_{mp} = \{ \begin{matrix}6 , & if {gp}_{ij} / ( 1 - k ) < 6 \\ {gp}_{ij} / ( 1 - k ) & else\end{matrix}$$
modulation parameter k is defined as following:
$$k = \{ \begin{matrix}( 90 - {I}_{ij} ) / 90 & for 0 \leq {I}_{ij} < 90 \\ 0 & for 90 \leq {I}_{ij} \leq 137 \\ ( {I}_{ij} - 137 ) / 137 & for 137 < {I}_{ij} \leq 255\end{matrix}$$
gp_{if} is calculated as following:
gp_{if}=(∇I)_{if}·\vec{n}
wherein I is the gray scale of the point, \vec{n} is the direction of the velocity of the point,
scaling parameter a is calculated as following:
$$α = exp ( 1 - k ) or α = \frac{1}{1 + {( \frac{k}{0.5} )}^{2 n}}$$
and f (scale) corresponds to the size of the nodule.

5. The process of claim 3, wherein parameter f (scale) in the velocity function is formulated as:
$$f ( scale ) = \{ \begin{matrix}1 & if scale 0 \\ 2 & if scale 1\end{matrix}$$
wherein scale 0 corresponds to the nodule with size in 5 to 15 mm and scale 1 corresponds to the nodule size in 15-30 mm.

6. The process of claim 3, wherein the arrival time u is calculated by resolving the following equation:
[max(D_{if}^{-x}u,−D_{if}^{+x}u,0)²+max(D_{if}^{-y}u,0)²]^{½}=1/V_{if},
wherein D⁻ and D⁺ are forward and backward operators.

7. The process of claim 3, wherein the stop criterion is set to be the arrival time≧T0, which can be predefined flexibly.

8. An apparatus for segmenting a lung nodule in a chest radiograph, which comprises of:
a preprocessor preprocessing the chest radiograph to obtain a preprocessed image;
a segmentation processor segmenting the nodule in the image based on fast marching method; and
a video processor for outputting the segmentation result to a display.

9. An apparatus of claim 8, wherein the preprocessor enhancing nodule in the chest radiograph to obtain a nodule-enhanced radiograph; enhancing rib in the chest radiograph to obtain a rib-enhanced radiograph; obtaining a nodule-rib difference image by subtracting the nodule-enhanced radiograph with the rib-enhanced radiograph; and applying anisotropic filter to the nodule-rib difference image.

10. An apparatus of claim 8, wherein the segmentation processor comprises of initial detector operable to detect seed points of the nodule; and
segmentation propagating means operable to propagate the segmentation with the fast marching method.
